(19) United States
(12) Patent Application Publication
(10) Pub. No.: US 2025/0370904 A1
(43) Pub. Date: Dec. 4, 2025

(54) MULTIDIMENSIONAL ERROR CAUSAL ANALYSIS FOR ERROR INTERCORRELATIONS THAT IMPACT APPLICATION AVAILABILITY

(71) Applicant: PAYPAL, INC., San Jose, CA (US)

(72) Inventors: Radha N, Chennai (IN); Karthick Sundaram, Chennai (IN); Lenin Velu, Chennai (IN)

(21) Appl. No.: 18/677,682

(22) Filed: May 29, 2024

(51) Int. Cl. G06F 11/36

(52) U.S. Cl. CPC G06F 11/3608

(57) ABSTRACT

Accuracy, reliability, and response speed improvements for software applications executed by a computing system or platform are provided herein. There are provided systems and methods for multidimensional error causal analysis for error intercorrelations that impact application availability. A service provider may utilize different computing services for data processing to provide different computing services to users, such as via websites and/or applications of the service provider. Due to errors, users may be unable to utilize applications or may face decreased performance and application availability. To improve application performance, error causal analysis may be performed that identifies error intercorrelations that impact application availability and other performance by identifying error effects on each other. Causal statements may be intelligently generated to then identify error intercorrelations. Once generated, these statements may be tested and verified to allow debugging teams and others to fix errors that reduce application performance and availability.

### TECHNICAL FIELD

The present application generally relates to error detection and reporting in computing systems and applications, and more particularly to scaling error alerts and reporting based on conversion metrics for completion of data processing flows.

### BACKGROUND

Users may utilize online service providers and corresponding computing systems and services to perform various computing operations and view available data. Generally, such computing operations are provided by online platforms and systems, which may provide applications and services for account establishment and access, messaging and communications, electronic transaction processing, and other types of available services. During performance of these operations, the service provider may utilize one or more applications to process data, which may include use of data processing flows having different steps or stages. However, errors during application execution, runtime, processing of real-time data by applications, and/or in a production computing environment may lead to failures, timeouts, and other errors in applications, resulting in poor application availability and performance due to failed, inaccurate, or unreliable computing services.

Application availability is a critical key performance indicator (KPI) for application performance, which may be used to indicate an overall observable system health. Conventional error analysis, debugging, site reliability engineering (SRE), and other error handling systems merely collect data on detected errors and report when sufficient errors are detected, which may not provide insight to upcoming errors that may affect application availability, and why such errors may cause applications to fail or become unavailable. As such, these error analysis systems may be insufficient to properly predict and handle errors, which may decrease application availability. This may cause significant negative impact to users, including loss of users and/or poor user experiences. As such, there exists a need for faster and more accurate predictive error analysis and detection that results in increased application available and improved system functionality for better user experience.

### BRIEF DESCRIPTION OF THE DRAWINGS

FIG. 1 is a block diagram of a networked system suitable for implementing the processes described herein, according to an embodiment;

FIG. 2 is an exemplary application diagram of an application that encounters correlated errors affecting application availability and other performance metrics of the application, according to an embodiment;

FIGS. 3A and 3B are exemplary diagrams of error data converted to causal statements for identification of error intercorrelations based on multidimensional error causal analysis, according to an embodiment;

FIG. 4 is a flowchart of an exemplary process for multidimensional error causal analysis for error intercorrelations that impact application availability, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for multidimensional error causal analysis for error intercorrelations that impact application availability. Systems suitable for practicing methods of the present disclosure are also provided.

A service provider, such as an online transaction processor, may provide computing services to users and/or their corresponding entities through web-based and dedicated software applications. These users and entities may include end users and customers, merchant customers for an online transaction processor, businesses and their representatives and/or employees, and the like. The computing services may include those associated with electronic transaction processing, payments, and/or cryptocurrency trading and payment processing. In order for users to utilize computing services of a service provider, the service provider (e.g., an online transaction processor, such as PAYPAL®) may require users and other entities requesting the services to have an account with the service provider. A user wishing to establish an account may first access the online service provider and request an account be set up and/or created. Account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or financial investments. The user may also establish, purchase, trade, and/or store cryptocurrency (e.g., through storage, exchange, and/or use of private keys for cryptocurrency values, tokens, or digital currency). This information may be used to process transactions for items and/or services and provide assistance to users with these payment instruments and/or payment processing. The account creation may establish account funds and/or values, such as by transferring money into the account and/or establishing a credit limit and corresponding credit value that is available to the account and/or card. Funds may also be established by storing private keys and/or generating, maintaining, and/or linking to an online digital “hot” wallet and/or offline digital “cold” wallet for cryptocurrency. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like. Similarly, the merchants may use the accounts when providing their merchant services to customers, such as during electronic transaction processing. Different online use of accounts and/or computing services of the service provider may correspond to requests, activities, and/or interactions for one or more events that occur and may be processed by the computing applications, platforms, and/or systems of the service provider, such as by using a networked, server-based, and/or cloud computing infrastructure and service. However, availability of the applications may affect the capability of users to engage with the computing services and the user experience with the service provider.

Application availability for various applications of a service provider may exhibit different trends when measured over a time period, where system and/or application changes may have many different causes that contribute to increases or decreases in availability. The daily fluctuations in availability with daily error logs may provide information regarding how the application availability changes in the system over time and/or due to certain events, such as errors. Errors may occur during use of computing services, and users may be adversely impacted. This may cause drop-off and abandonment of users or transactions, as well as poor user/customer experiences, which may negatively impact retention rate. As such, a service provider may identify error intercorrelations through multidimensional error causal analysis, which may allow for more proactive and intelligent error resolution and/or improved application availability through predictive error handling.

In one embodiment, a solution may use data in a specific timeframe to identify the impact on availability caused by various direct errors, indirect errors and availability fluctuations, which may be analyzed using machine learning (ML) models and algorithms, including neural networks (NNs) or other artificial intelligence (AI) techniques. The data may include system error logs, application success request logs, application total request logs, and the like. For example, the data may include system error logs with error names and their respective count by application for a fixed time frame. The successful request counts and total request counts may be pulled for the fixed time frame per application. The successful and total requests may be used to derive availability information. For example, software application availability may be directly and/or indirectly correlated with application success request per application total requests.

Error count and availability fluctuation data may be prepared for causal effect analysis using availability as the outcome. This may assist with identifying the error relations with one another including direct error causes, indirect error causes which cause another error, and the like. The error intercorrelation analysis identifies causal statements that demonstrate the influence of direct error causes in the presence of indirect causes for a specific error. This analysis also provides a confidence value of the causal statement. The prepared input data may be input to a tree-based prediction model or other ML model, NN, or the like. Such a model may allow for the feature importance of other errors with respect to a specific error to be identified. Predictor errors with a feature importance above a threshold (e.g., 30% to 90%) on a target error may be considered as a potential error cause for that error.

This analysis may generate a hypothesis to test errors with a cause-and-effect analysis. The causal effect analysis may be performed for each cause in the feature space considering the other feature parameters as indirect causes. The causal effect analysis may result in determining a value from hypothesis testing, which may be used to generate causal statements based on the confidence percentage of an error causing another error. As such, the causal effect analysis may use the above feature space for each application to identify direct and indirect causes of errors and impacted application availability. This analysis may be performed using Ordinary Least Squares regression (OLS) or a DoWhy Python library having identification, estimation, and refutation ML functions for causal inferencing.

The identified causal statements may have the following outputs after causal effect validation: direct error causes, indirect error causes, confidence value of the causal statement, influence percentage on target error, and/or a positive/negative influence on the target error. Availability of an application can be compared with respect to an agreed service level objective (SLO) or specific threshold as defined by one or more business rules or logic, such as a business rule threshold. As such, this may create two groups in the software application availability data: a first group for application availability above the business threshold/SLO and a second group for application availability below the business threshold/SLO.

Initially, a mathematical transformation may be performed. This may help magnify the availability values based on a business threshold/SLO and/or the minimum availability observed in the timeframe. The mathematically transformed availability data may then be input to a baseline anomaly detection model that identifies points of abnormal fluctuations in the availability data. The anomaly detection may be performed with mathematical transformation to magnify the effect of slight availability changes. Further, a baseline anomaly detection model and Gaussian based clustering may be used to smoothen the detected anomalies, which allows marginal deviation on detected anomalous points. Thereafter, a data table may be created with a labeled column with 0 for non-anomalous points and 1 for anomalous points when the anomaly detection score and clustering is computed by each software application.

Thereafter, error rates for software application availability may be calculated. Error rates may be calculated using one or more formulas, for example, the following: Error rate for an application availability=100−((success request count)=(total request count)). The potential causes of errors may be generated for hypothesis testing based on the calculated error rates. The error rate thresholds that may be used to identify error rates for testing may be decided based on manual input or intelligently from past learning of error rates. Errors in applications with error rates above the identified thresholds may therefore be considered for hypothesis testing. The availability fluctuations for the identified errors may also be considered for causal effect analysis. The causal effect analysis may be performed at the software application level for a feature space corresponding to the errors and error rates that are greater than the business thresholds. The feature space for errors may be generated using predictive analysis. The errors may correspond to independent factors and the error rates may correspond to dependent factors for each application.

When the causal effect analysis is performed for each application, each cause in the feature space may be considered with the other feature parameters as indirect causes of the error. The causal effect analysis may result in values from hypothesis testing based on the confidence percentage, which may then be used to generate causal statements. Thus, the causal effect analysis uses the feature space for each application with potentially generated direct and indirect causes. The generated causal statements having outputs for direct causes, indirect causes, confidence value of the causal statement, availability impact, and/or decrease/increase in availability may then be used to assess application availability based on each error's impact on other errors, and therefore overall application availability. For example, a causal statement may state that error 1 causes −0.23% reduction in availability in the presence of other influencing factors including availability fluctuations, an error 2, and/or an error 3. Further, the availability impact confidence score for such causal statement may be 90%. The confidence for causal statements may correspond to metrics for cause-and-effect evaluation that may be calculated.

In this manner, a service provider may provide an automated and predictive error detection and alerting platform for errors that cause data processing failures and other application issues through causal analysis. This may allow for faster, more accurate, and more efficient identification of errors and reductions in application availability or other application KPIs that affect application usage and/or user experience in-application. This may also assist with detecting and preventing multiple errors from compounding and causing more serious and harmful application availability reduction and/or application data processing issues. Such processes may allow for multi-dimensional detection of error impacts on other errors and compounded correlations between such errors, enabling root causes of application availability and other KPI reductions to be identified, remedied, and fixed. As such, service providers may provide reliable applications and data processing in a timely and efficient manner where users encounter less errors and reductions in application availability, processing speeds, and other performance. Thus, the service provider may provide more widely available, more efficient, more robust, and less faulty applications and user experiences with applications and computing platforms.

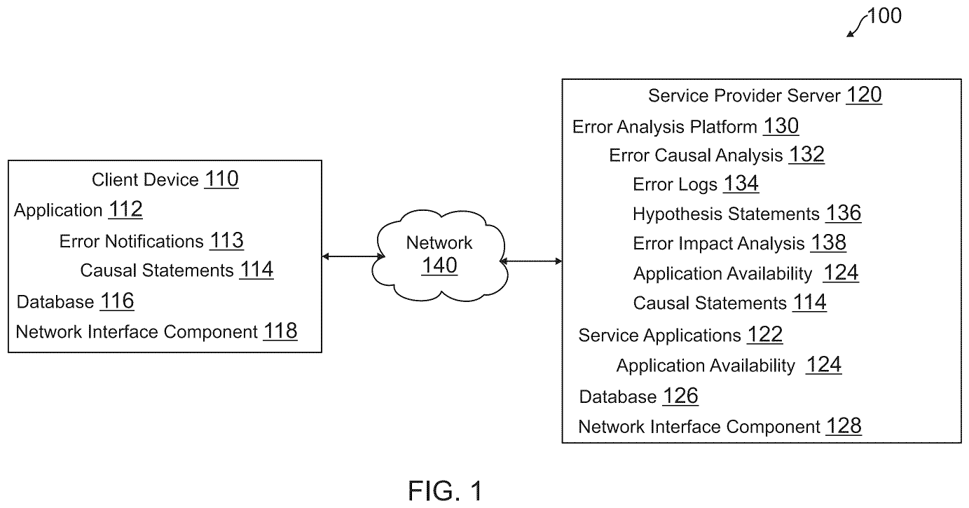

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by a system administrator, debugging team member, or other user that provides assistance with and repair of computing errors that may be caused during the use of applications, websites, and other resources of service provider server 120, where service provider server 120 may provide various data, operations, and other functions to client device 110 and/or other devices, servers, and/or platforms via network 140. Alerting of client device 110 may be based on error intercorrelations determined from a multidimensional analysis of error logs and error impacts on application availability or other application performance. Service provider server 120 may analyze error logs and errors impacting application availability based on KPIs or other performance parameters. Causal statements may be generated and analyzed or tested using data for application availability and anomaly detection operations or processes, where results may indicate whether the causal statements of error intercorrelations affecting applications are correct and a confidence value in such statements.

Client device 110 and service provider server 120 may each include one or more processors, memories, and other appropriate components for executing instructions such as program code and/or processing data stored on one or more computer readable mediums to implement the various applications, process data, and steps described herein. For example, such instructions and data may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider server 120 and/or other devices or servers. Client device 110 may be utilized, for example, by internal end users, team members, and the like that may assist with error resolution for service provider server 120. In some embodiments, client device 110 may be implemented as a single or networked set of personal computers (PCs), servers, a smart phone, laptop computer, wearable computing device, and/or other types of computing devices. Although only one device is shown, a plurality of devices may function similarly.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user for use with service provider server 120, such as to provide access to and service of computing services provided by service provider server 120 (e.g., error maintenance, resolution, and other assistance). In this regard, application 112 may correspond to specialized software utilized by a user of client device 110 to receive error notifications 113 and respond to error notifications 113 based on causal statements 114, such as by reviewing causal statements 114 to identify error intercorrelations and dependencies that affect application availability and/or performance, review network traffic, firewall, and other computing logs, and the like, and/or provide error resolution, troubleshooting, and/or remediation actions. As such, application 112 may be utilized to address issues causing the errors identified in causal statements 114 and/or by error notifications 113 including system, application, and/or website maintenance, debugging, code changes or updates, update rollout or rollback, testing and troubleshooting, and the like.

A Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 during error resolution and review of error notifications 113 including specialized software for malware, debugging, sandbox environments for testing, system analysis or diagnostics, and the like. Thus, application 112 may also correspond to different service applications and the like. When utilizing application 112 with service provider server 120, application 112 may request and/or receive error notifications 113, where error notifications 113 may include causal statements 114 generated intelligently by service provider server 120 through analysis of error logs and error intercorrelations.

Client device 110 includes other applications as may be desired to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include those that may be utilized in the course of system administration, maintenance, debugging, error resolution, engineering, and the like. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or be associated with database 116, which may store various applications and data and be utilized during execution of various modules of client device 110. Database 116 may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for user/device authentication or identification, which may be communicated as identifying the user/client device 110 to service provider server 120.

Client device 110 includes at least one network interface component 118 adapted to communicate with service provider server 120 and/or another device or server. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide computing services that utilize and/or provide data processing through service applications 122, where reliability and integrity of such applications may be maintained in a more efficient, predictive, and reliable manner through multidimensional analysis of error intercorrelations and generation or causal statements for errors affecting application availability and/or performance. In this regard, service provider server 120 includes one or more processing applications which may be configured to interact with computing devices, for example, to provide services to customer devices and/or alert client device 110 of errors occurring at steps in data processing flows. In one example, service provider server 120 may be provided by PAYPAL®, Inc. of San Jose, CA, USA. However, service provider server 120 may be maintained by or include another type of service provider.

Service provider server 120 of FIG. 1 includes an error analysis platform 130, service applications 122, a database 126, and a network interface component 128. Error analysis platform 130 and service applications 122 may correspond to executable processes, procedures, and/or applications with associated hardware. In other embodiments, service provider server 120 may include additional or different modules having specialized hardware and/or software as required.

Error analysis platform 130 may correspond to a digital platform, software application and/or application architecture, or the like that may include one or more processes that execute modules and associated specialized hardware of service provider server 120 to perform error causal analysis 132 to identify error intercorrelations impacting and reducing application availability and other application performance(s), such as those that may result in reductions of KPIs or other performance parameters. Such analysis may be applied to service applications 122 or other software applications, which may be internal and/or external, and be based on application data including incoming and/or streaming data, such as in real-time and/or from data events and requests being processed. As such, error analysis platform 130 may be used in conjunction with service applications 122 to provide error analysis and identification of error intercorrelations for direct and indirect errors causing availability and/or performance fluctuations.

In this regard, error analysis platform 130 may correspond to specialized hardware and/or software that may utilize and/or access data from different data components to process error logs 134 and generate hypothesis statements 136 based on errors, error counts, and/or application availability. Error analysis platform 130 may include an error impact analysis 138, which may process error logs 134 to generate hypothesis statements 136, which may then be tested using application availability 124 for service applications 122 to output causal statements 114 that identify error intercorrelations that affect application availability, KPIs, and/or other performance indicators and/or measurements of application health, performance, and/or usage. As such, error impact analysis 138 of error analysis platform 130 may process data from service applications 122 during use of such applications and computing services by users and entities, which may include detected errors and application request logs for requests from users. The users may be engaged in one or more of processing flows for data processing of requests and other events, and requests may be provided for data processing. The requests may be logged as received and successful, such as application success request logs and application total request logs. As such, during processing of data during processing flows, a failure or other error may occur, which results in a request not being successful and contributing to the total requests but not the successful requests. Errors that cause requests to fail to complete and/or convert may also be logged, such as system error logs. These failures and errors result in failure of data processing and completion of requests for data, which requires error maintenance and resolution to fix and resolve for less interruptions and poor experiences during interactions by users.

As such, when error logs 134 are received and/or determined for error impact analysis 138, error impact analysis 138 may be invoked for processing error logs 134 to identify when errors occur together and how those errors affect application availability or other performance as indicated by application successful requests versus application total requests or other KPI and/or performance indicator. Error impact analysis 138 may correspond to a software daemon or other executable application or process, which may run automatically and/or in a background computing environment, which processes error logs 134 and generates hypothesis statements 136, which may then be tested to create causal statements 114 and corresponding error data and alerts to teams, team members, error handlers, and other endpoints of errors with a prioritization designation, as discussed herein. In this regard, the software daemon or other software application, operation, or component may run or execute with different components to monitor outputs and/or detect failures of data processing with error logs 134. An intelligent engine of error impact analysis 138 may then compute causal statements 114 from testing of hypothesis statements 136 based on the data prepared for the causal study, an anomaly detection operation or the like, and/or other error impact analysis processes and intelligent computations.

Error impact analysis 138 may include ML or neural network (NN) models trained using training data to generate hypothesis statements 136 and/or test such statements to make predictions of causal statements 114. When building such AI models, training data may be used to generate one or more classifiers and provide scores, decisions, predictions, or other outputs based on those classifications and an ML or NN model algorithm and/or trainer. Feature engineering and/or selection may be used to select a set of input features and their corresponding data used during training and inference phases of the ML, NN, or other AI models of error impact analysis 138, such as scores for input data for those features, and whether those scores meet or exceed a threshold for error intercorrelation that sufficiently affects application availability or other performance (e.g., over a threshold rate or level, such as a 10% reduction in application availability). For example, ML models for error impact analysis 138 may include one or more layers, branches of a tree, or the like, including an input layer/node(s), a hidden or intermediary layer/node(s), and an output layer/node(s) having however, different configurations may also be utilized. As many hidden or intermediary layers/nodes as necessary or appropriate may be utilized.

Each node for data processing in a decision tree, neural network, or the like may be connected to a node within an adjacent layer, pathway, branch, or the like, where a set of input values may be used to generate one or more output values or classifications. Within the input nodes, each node may correspond to a distinct attribute or input data feature that is used to train AI models for error impact analysis 138 and during model inference, for example, using feature or attribute extraction. When training, the features may correspond to error logs 134 and other events, scenarios, or contexts for errors logs 134. For example, contextual features for errors, application availability or performance metrics, and the like, may be used including business thresholds, service level agreement (SLO) requirements, and other effects on application availability or performance. For example, an availability or other performance metric of an application may be compared to an agreed-upon SLO or specific threshold for a business rule or requirement.

Nodes that are hidden or intermediary between the input and output of the ML models or NNs of error impact analysis 138 may be trained with these attributes and corresponding weights using an ML or NN algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden nodes and/or branches may include different algorithms and/or different weights assigned to the input data and may therefore produce a different value based on the input values. The values generated by the hidden nodes or branches may be used by the output layer node to produce one or more output values for error impact analysis 138 that attempt to classify whether errors are correlated and therefore hypothesis statements of error intercorrelation affecting application availability or other performance is sufficient to generate causal statements 114. Thus, when error impact analysis 138 is used to perform a predictive analysis and output, the input may provide a corresponding output based on the classifications trained for generation of hypothesis statements 136 and corresponding validation to output causal statements 114.

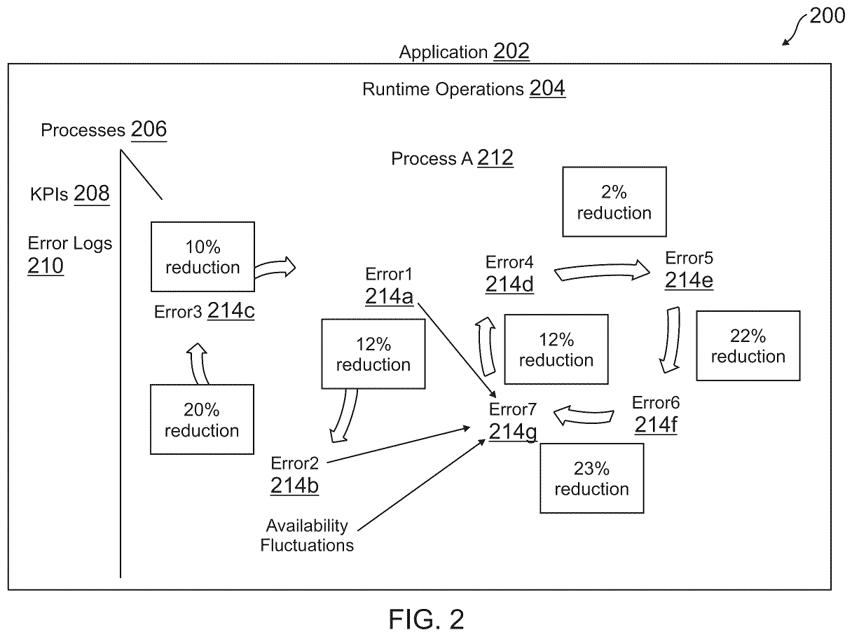

ML models for error impact analysis 138 may be trained by using training data associated with error logs 134 and other model features. By providing training data to train the ML models or NNs of error impact analysis 138, the nodes in the layers, branches, or the like may be trained (adjusted) such that an optimal output (e.g., a classification) is produced in the output based on the training data. By continuously providing different sets of training data, as well as penalizing the ML models or NNs when the output of error impact analysis 138 is incorrect, those models and networks of error impact analysis 138 (and specifically, the representations of the hidden nodes) may be trained (adjusted) to improve performance in data classification and determination of causal statements 114. Adjusting and retraining may include adjusting the weights associated with each node in the hidden layers, branches, or the like. Thus, the training data may be used as input/output data sets that allow for error impact analysis 138 to make classifications based on input attributes. The operations and components used to create and validate hypothesis statements 136 so that causal statements 114 may be output are described in further detail below with regard to FIGS. 2A-4.

Service applications 122 may correspond to one or more processes to execute modules and associated specialized hardware of service provider server 120 to provide computing services for account usage, digital electronic communications, electronic transaction processing, and/or other services utilized through customer and other user devices. In this regard, service applications 122 may correspond to specialized hardware and/or software used by service provider server 120 to provide, such as to customers, merchants, and other users, one or more computing services. Service applications 122 may correspond to electronic transaction processing, account, messaging, social networking, media posting or sharing, microblogging, data browsing and searching, online shopping, and other services available through service provider server 120. Service applications 122 may be used by a user to establish an account and/or digital wallet, which may be accessible through one or more user interfaces, as well as view data and otherwise interact with the computing services of service provider server 120. In various embodiments, financial information may be stored to the account, such as account/card numbers and information. A digital token or other account for the account/wallet may be used to send and process payments, for example, through an interface provided by service provider server 120. The payment account may be accessed and/or used through a browser application and/or dedicated payment application, which may provide user interfaces for use of the computing services of service applications 122. Although account, payment, and electronic transaction processing services are described above, service applications 122 may also provide other computing services including social networking, media posting or sharing, microblogging, data browsing and searching, online shopping, and other services.

The computing services may be accessed and/or used through a browser application and/or dedicated software application, such as a payment application, which may include mobile applications. Such account services, account setup, authentication, electronic transaction processing, and other computing services of service applications 122 may load, serve, and/or operate on data from events and/or based on requests from customer devices. In some embodiments, such requests may be processed through processing flows that are logged with regard to application availability 124. In this regard, if processing of requests and events fail and affect application availability 124, error analysis platform 130 may be invoked and utilized to generate alerts to client device 110 and/or other endpoints of causal statements 114 generated based on error intercorrelations as identified intelligently from multidimensional causal analysis. Service applications 122 may provide information regarding failed requests and events, as well as their corresponding errors, and may provide the data for error analysis platform 130 for processing. This may include application availability 124 for the uptime, downtime, success and/or total requests, KPIs, and/or other performance metrics, measurements, and/or indicators of application usage, success, health, and/or processing results.

Additionally, service provider server 120 includes and/or is able to access database 126. Database 126 may store various identifiers associated with client device 110 and/or other devices, servers, and components. Database 126 may also store account data, including payment instruments and authentication credentials, as well as transaction processing histories and data for processed transactions. Database 126 may store financial information and tokenization data, as well as data associated with error logs 132 and/or causal statements 114, including alerts and/or identification or errors for resolution. Although database 126 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate with client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary application diagram 200 of an application that encounters correlated errors affecting application availability and other performance metrics of the application, according to an embodiment. Application diagram 200 of FIG. 2 includes an application 202 executing runtime operations 204, such as one or more of service applications 122 of service provider server 120 discussed in reference to system 100 of FIG. 1. In this regard, application diagram 200 displays the errors that may be encountered during application runtime and processing, which may be analyzed by error analysis platform 130 of service provider server 120 for error intercorrelation analysis and identification.

From application diagram 200, error analysis platform 130 may analyze logs of errors that may occur during runtime operations 204 of application 202. In this regard, runtime operations 204 include processes 206, and application performance of application 202 may be indicated by monitored and/or tracked values, metrics, and the like for KPIs 208 (e.g., application availability or other performance indicators, such as latency, response time, abandonments, etc.) and error logs 210. Processes 206 include a process A 212, which may be executed to process requests from clients including computing devices of users, internal and/or external devices, servers, and/or component, and other endpoints. For example, process A 212 may correspond to a transaction processing process performed using one or more executable tasks, decision services or microservices, and the like, which may process data, execute calls, and perform other actions to provide a result to a user.

As such, during execution of process A 212, errors 214a-f may occur, which each result in a reduction in application availability or other adverse effect on application performance and operational metrics. Errors 214a-f may be indicated by changes to KPIs 208 and may be logged with their corresponding occurrence of data, communications, network calls, and the like in error logs 210. For example, error logs 210 may identify error1 214a based on the actions that result in the failure to process a request or otherwise cause an adverse action when processing a request. Error logs 210 and/or other monitoring by error analysis platform 130 may therefore identify information include requests successfully processed, total requests, and the like that indicate reductions or other adverse effects on application availability, performance, and the like.

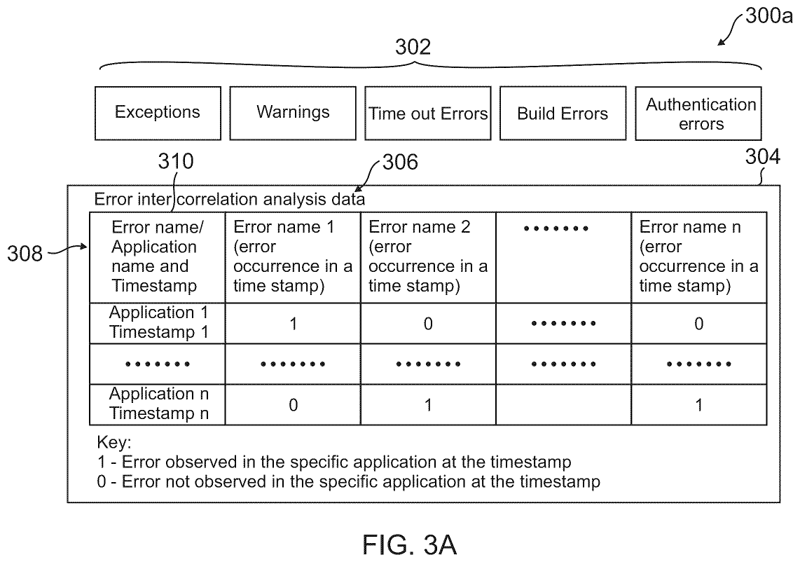

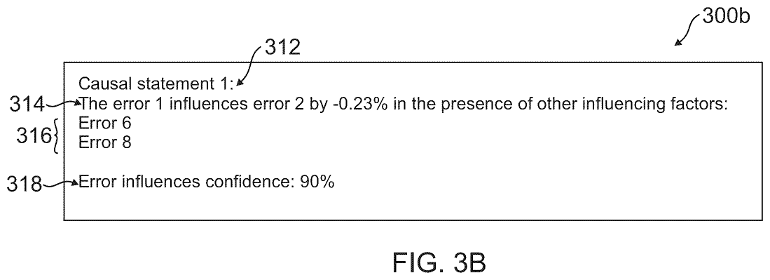

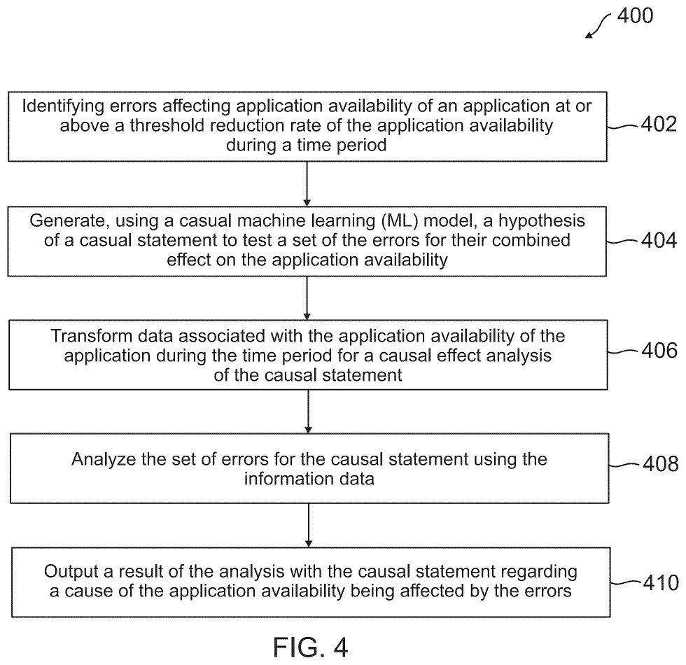

For example, during runtime operations 204, each of errors 214a-f show a correspond fluctuation in application availability or other performance indicator. Each may be compounded by affecting another, where a reduction caused by error1 214a of 12% may cause an impact on error2 214b to have a 20% total reduction. Error1 214a and error2 214b may also have an impact on error7 214g, which may be analyzed through a hypothesis of a causal statement. For example, normally, error7 214g may have a 12% reduction in application availability that is caused by the error. However, to determine an overall impact and correlation between error1 214a, error 2 214b, and error7 214g, a hypothesis of a causal statement from errors 214a-g may be generated, as discussed in further detail below with regard to FIGS. 3A-4. Error analysis platform 130 may then utilize an intelligent engine or process, such as an ML model, NN, or other AI-based technique, to perform causal statement generation. The hypothesis of the causal statement may also be tested by processing the data for KPIs 208 and error logs 210, which may be done through mathematical transformations and comparison of reduced availability and/or performance to threshold requirements.

FIGS. 3A and 3B are exemplary diagrams 300a and 300b of error data converted to causal statements for identification of error intercorrelations based on multidimensional error causal analysis, according to an embodiment. Diagram 300a displays data prepared for analysis by a causal ML model, such as a tree-based prediction model trained to identify and process feature importance of other features on a feature. As such, the data table in diagram 300a may be prepared for processing by such a causal ML model during error causal analysis 132 by error analysis platform 130 of service provider server 120 discussed in reference to system 100 of FIG. 1. Diagram 300b shows an output of a causal ML model trained to identify error intercorrelations and effects on a direct or specific error from feature importance, where the causal statement may correspond to an initial hypothesis statement that is then tested and verified using transformed data and threshold decisioning. As such, diagrams 300a and 300b may correspond to diagrams of error data and resulting causal statements that may be processed to determine error intercorrelations and affects on application availability and/or performance.

For example, error flags 302 in diagram 300a present different types of errors and corresponding error data that may be processed when generating an error intercorrelation analysis data table 304. Data for error flags 302 may come from different application log sources, such as error logs, application success request logs, and application total requests logs, which may be generated during application runtime, request processing, and/or from monitoring the application during runtime. Error intercorrelation analysis data table 304 may include data for KPIs and other indicators, metrics, or measurements that may include or be associated with application availability, performance, health, or other operational requirement of a corresponding software application. Further, the data for error flags 302 may include information that indicates fluctuations in the KPIs or other indicators over time, during a time period, or the like so that impact on availability may be determined from direct and indirect errors. The data may contain system error logs with error names and their respective count by application for a fixed time frame. The successful request counts (e.g., those requests successfully processed) and total request counts (e.g., all requests received) may be pulled for the fixed time frame to derive availability information and the like, which may correspond to the successful requests divided by the total requests (or other computation).

In this regard, error intercorrelation analysis data table 304 includes error intercorrelation analysis data 306 having rows 308 for each data entry or record and columns 310 for the corresponding data key or value for analysis. For example, columns 310 may include an error name and occurrences at timestamps 1 through n. Using error intercorrelation analysis data table 304, error intercorrelation analysis data 306 may be input to a causal ML mode, such through imputation using a tree-based prediction model or the like (although other models and/or algorithms may be used including NNs and the like). Predictor errors (e.g., indirect errors) with a feature importance at or above a threshold on a target error may be considered as potential errors causes for that error. For example, where the features and occurrences correlate the indirect errors with a direct error as occurring together and/or causing a sufficiently high level or amount of availability or performance decrease or reduction of the application, those indirect errors may be hypothesized to be the cause of the direct error. As such, a hypothesis may be generated to test with a cause-and-effect analysis (e.g., hypothesis 0—the identified error does not influence the target error or hypothesis 1—the identified error influences the target error).

Referring now to FIG. 3B, diagram 300b shows the output of the causal ML model, which may then be tested for verification and/or alerting of an error resolution endpoint, team, debugging process or user, or the like. Causal statement 312 indicates how an error 1 influences an error 2 when in the presence of other errors 6 and 8. For example, an effect 314 indicates that error 1 influences error 2 by −0.23% (e.g., causes a further reduction in application availability or other performance metric by 0.23%) when a cause 316 occurs, that is that cause 316 indicates errors 6 and 8 are present. As such, causal statement 312 includes a cause 316 and an effect 314 for testing. With causal statement 312, an error influence confidence 318 is provided, such as a score, rating, or other measurement of the causal ML models accuracy or confidence in the cause-and-effect being correct. Thus, a hypothesis of causal statement 312 is generated as the output of the causal ML model.

Thereafter, causal statement 312 may be tested by determining whether cause 316 and effect 314 are accurate or valid based on availability data or other performance data for the application. For example, a causal effect analysis may be performed for each cause in the feature space for the ML model prediction or output (e.g., the set of features of the errors analyzed and their correlations at timestamps or within time periods). Each cause may correspond to an indirect error affecting the direct or selected error, and the causal effect analysis may be performed with OLS or a DoWhy library using identification, estimation, and refutation ML processes. After validation, the identified causal statements may have an output in the same or similar form to causal statement 312 in diagram 300b.

To perform error impact analysis for each indirect error on an error, data for the metric for availability, a KPI, or other performance of the application may be compared with respected to an agreed upon SLO or business rule threshold to create a set of transformed data used for testing. For example, availability data may be grouped by those at or above the threshold and those below the threshold, where the data for application availability under the threshold may be analyzed for error impacts that affect availability or performance. A mathematical transformation may be applied to magnify, emphasis, and/or highlight the availability values based on an SLO or business rule threshold, as well as the minimum availability observed in a timeframe. As such, the transformation may be performed using the following equations for imputation to a baseline anomaly detection model of an anomaly detection operation, process, or application. When availability data is below the threshold, the data may be transformed using 100−((availability value of an application at a specific timestamp-minimum availability value of an application for the considered time period or frame)=(threshold−minimum availability value of an application for the considered time period or frame)). When the availability data is at or above the threshold, the data may be transformed using 100−((availability value of an application at a specific timestamp-threshold)=(100−threshold)). Other performance metrics or measurements may be used in place of availability data.

Availability anomaly detection may then be performed to create a data set that allows for analyzing the hypothesis using linear regression causal models, software libraries, and the like. For example, the anomaly detection may be used to generate values or other data in columns for error data that indicates whether there was an anomalous change in application availability or other performance or not. As such, a baseline anomaly detection model and/or Gaussian-based clustering may be used to smoothen detected anomalies, which allow for marginal deviations while identifying the abnormal fluctuations or jerks in availability or other performance data. Thereafter, causal statement 312 may be verified, and if validated, output to one or more endpoints, users, computing services or applications, and the like for error resolution and/or remediation. This may include alerting debugging teams, performing automated rollbacks of versions or other updates, reverting to past data and/or operations, quarantining or otherwise preventing access to operations and/or data causing errors, and other tasks that may fix errors or prevent further drops in service coverage, availability, and the like.

FIG. 4 is a flowchart 400 of an exemplary process for multidimensional error causal analysis for error intercorrelations that impact application availability, according to an embodiment. Note that one or more steps, processes, and operations described herein of flowchart 400 may be omitted, performed in a different sequence, or combined as desired or appropriate.

Flowchart 400 in FIG. 4 includes steps executed by service provider server 120 with client device 110, such as using error analysis platform 130 when generating alerts for errors during computing service usage by users based on causal statements of error intercorrelations. As such, different portions of the steps of flowchart 400 are shown as being performed by, on, or with error impact analysis 138 when providing error notifications 113 and other data to client device 110 that may include causal statements 114. At step 402 of flowchart 400, errors affecting application availability of an application at or above a threshold reduction rate of the application availability during a time period are identified. The errors may be identified through analysis of and/or annotations from error logs that may be generated by an application and/or when monitoring an application for errors and error analysis. As such, errors may be tracked over a time period from error logs, where the error logs may include information that indicates application availability based on performance parameters of the application (e.g., KPIs, latency, throughput, request failures, etc.) and other availability data (e.g., successful and total requests and/or request volumes).

At step 404, using a causal machine learning (ML) model, a hypothesis of a causal statement to test a set of the errors for their combined effect on the application availability is generated. The identified errors may be associated with fluctuations in application availability, application performance, and/or other indicators of application health, availability for usage, and/or performance during execution of the application. For example, errors may be correlated with errors logs, application success request logs, and/or application total request logs, which may correspond to data sources provided as input to the causal ML model. The causal ML model may be trained based on features associated with inputs from the error logs, application success request logs, and application total requests logs, and as such, may generate and provide predictive outputs of direct errors and indirect errors that affect the direct error.

These outputs may correspond to hypothesis statements or hypothesis of causal statements that show the influence of other indirect errors on a direct error. As such, the causal statement may identify a direct error and show the error's reduction in application availability or other performance of an application when the error occurs, as well as when the error occurs in conjunction with and/or when influenced by one or more other indirect errors. Further, the hypothesis may be associated with a confidence value of the causal statement, which indicates how confident that the indirect errors cause the error. The hypothesis may then be tested with a cause and effect analysis, such as an anomaly detection operation, which seeks to determine whether the identified error influences or do not influence the targeted direct error to a sufficient degree or amount (e.g., over a threshold amount) to require remediation and error resolution when occurring together. For example, it may be required that the set of errors in the cause statement are required to meet or exceed a threshold reduction, impact, or effect on the application availability or other application performance indicator or parameter.

At step 406, data associated with the application availability of the application during the time period is transformed for a causal effect analysis of the causal statement. After generating causal statements, each cause of an error (e.g., the indirect errors on the direct error) may be identified and a causal effect analysis may be performed in a feature space for the parameters of the error and reduced application availability or performance. For example, a causal effect analysis may use the feature space for each application to identify direct and indirect causes of errors using OLS regression or a DoWhy Python library. These may each provide identification, estimation, and refutation ML functions for causal inferencing. In this regard, causal effect may be performed using an anomaly detection operation or process, where the availability of the application may be compared with respect to an agreed service level objective of specific threshold as defined by a business rule or other executable rule and/or rule library.

To transform the data for anomaly detection, a mathematical transformation may be applied that assists with magnifying, highlighting, emphasizing, and/or otherwise identifying fluctuations in application availability and/or performance caused by errors. In this regard, the mathematical transformance may be applied when above, at, and/or below the SLO or business rule threshold and may be based on the availability value of an application at a specific time, the minimum availability value of the application in a time period associated with that time, and the threshold. Thereafter, an anomaly detection may identify points of abnormal fluctuations in availability or performance data. This may then be used to test and validate, or disprove, the hypothesis of the causal statement.

At step 408, the set of errors for the causal statement is analyzed using the transformed data. The analysis of the set of errors may include performing a causal effect analysis based on the anomaly detection such that errors in the application with error rates indicated by the anomaly detection at or above the identified thresholds being considered for testing. If so, those causal statements may be validated and used for error alerting and detection. However, if not, further testing and/or hypothesis generation may be performed.

At step 410, a result of the analysis with the causal statement regarding a cause of the application availability being affected by the errors is output. Once a hypothesis of a causal statement is validated, the causal statement may be generated for output and provided with a notification to an error resolution endpoint, which may assist with error resolution and/or other remediation of errors. As such, a result and/or notification may be output to one or more users, devices, or the like, which may process the information for debugging and the like. The result and/or notification may include the error logs identifying the direct and indirect errors, as well as the effect of indirect errors on the direct error. Further, an error resolution process may be directed to the causes of the error (e.g., the indirect error(s)) with the reduction(s) in the application availability or performance caused by the errors when occurring together, such as a compounded effect of errors on each other.

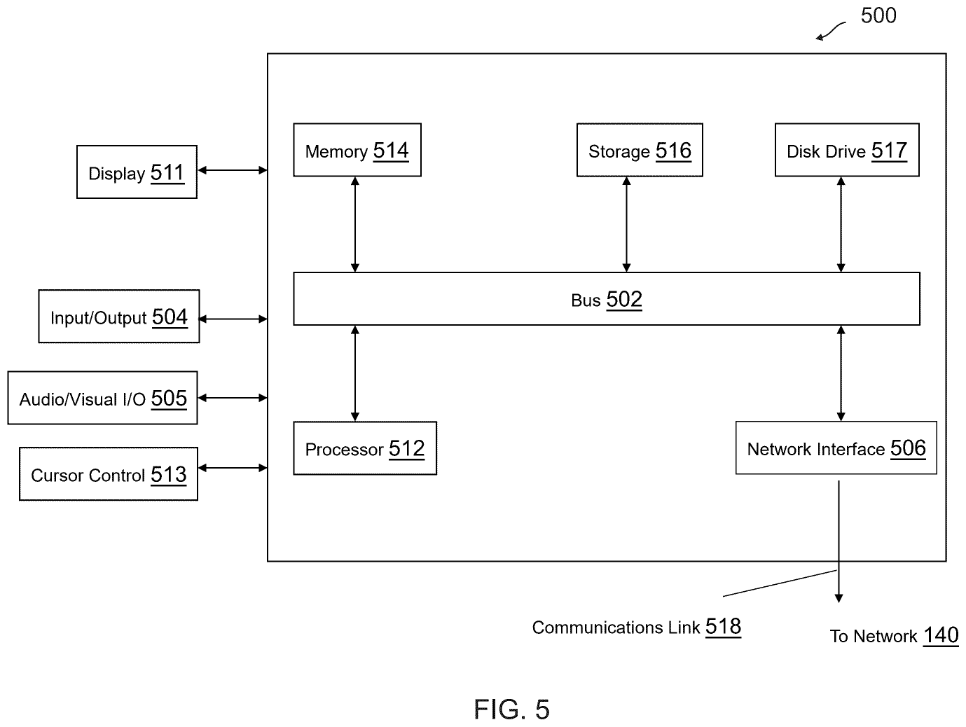

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
tracking, over a time period, errors in an application and availability data of the application based on error logs for the application and a first performance parameter of the application;
determining a plurality of errors affecting application availability of the application at or above a threshold reduction rate during the time period;
generating a first causal statement for a set of errors from the plurality of errors using a causal machine learning (ML) model, wherein the first causal statement is generated to test if the set of errors cause the application availability to be affected at or above the threshold reduction rate, wherein the causal ML model is trained to identify an importance of other errors on a selected error affecting the application availability;
determining data of the availability data of the application that is associated with the set of errors;
analyzing the set of errors based on an anomaly detection operation and the determined data, wherein the analyzing includes determining whether the set of errors combine to cause the application availability to be affected at or above the threshold reduction rate; and
outputting, with the first casual statement, a result of the analyzing.

2. The method of claim 1, wherein the result comprises at least one direct error and at least one indirect error of the set of errors causing the application availability to be affected at or above the threshold reduction rate, wherein each of the at least one direct error and the at least one indirect error have a corresponding reduction rate of the application availability when occurring in the error logs, and wherein the result further comprises a confidence value of the application availability being affected due to the first causal statement.

3. The method of claim 1, wherein the set of errors for the first causal statement reduces the application availability from a production level availability during a runtime of the application in a production computing environment.

4. The method of claim 1, further comprising:
providing one or more of the error logs and the determined availability data for the set of errors with the result.

5. The method of claim 4, wherein the providing includes notifying an error resolution endpoint of the first causal statement with the one or more of the error logs and the determined availability data.

6. The method of claim 1, wherein the result further comprises a pattern analysis of the set of errors affecting the application availability based on the analyzing, and wherein the pattern analysis indicates a causation of the set of errors from the error logs.

7. The method of claim 1, wherein the determining data of the availability data comprises transforming the availability data to identify one or more fluctuations in the application availability caused by the set of errors using a computation associated with a service level agreement (SLO) threshold or a business rule threshold.

8. The method of claim 1, wherein the causal ML model is trained based on features associated with inputs from the error logs, application success request logs, and application total requests logs.

9. A system comprising:
a non-transitory memory; and
one or more hardware processors coupled to the non-transitory memory and configured to execute instructions to cause the system to:
generate a causal statement for a plurality of errors linked to a reduction in an application performance of an application using a causal machine learning (ML) model, wherein the causal statement includes at least one direct error and at least one indirect error from the plurality of errors that combine to cause the reduction;
determine performance data of the application and comprising measurements of the application performance at points in time corresponding to the plurality of errors;
analyze the causal statement based on an anomaly detection operation and the performance data;
determine a confidence value in the causal statement causing the reduction in the application performance based on analyzing the causal statement; and
notify an error resolution endpoint of the causal statement having the plurality of errors and the confidence value.

10. The system of claim 9, wherein the application performance is associated with one of at least one key performance indicator (KPI) for the application, an application availability for the application, or an application health indicator for the application.

11. The system of claim 9, wherein executing the instructions further cause the system to:
determine, prior to generating the causal statement, a feature importance of indirect errors on a direct error using the causal ML model; and
select the plurality of errors for the causal statement based on the feature importance, the causal ML model, and feature importance threshold.

12. The system of claim 11, wherein generating the causal statement comprises generating a hypothesis of the causal statement for testing using the anomaly detection operation and the performance data.

13. The system of claim 9, wherein notifying the error resolution endpoint comprises providing a report of one or more error logs associated with the plurality of errors to the error resolution endpoint.

14. The system of claim 13, wherein the report further includes a pattern analysis of the reduction in the application performance from each indirect error in the plurality of errors that affects a direct error in the plurality of errors.

15. The system of claim 9, wherein determining the performance data comprises transforming the performance data to identify one or more fluctuations in the application performance caused by the plurality of errors using a computation associated with a service level agreement (SLO) threshold or a business rule threshold.

16. The system of claim 9, wherein the causal ML model is trained based on features associated with inputs from error logs associated with the plurality of errors, application success request logs, and application total requests logs.

17. A non-transitory machine-readable medium having stored thereon machine-readable instructions executable to cause a machine to perform operations comprising:
receiving error logs for an application that record a plurality of errors affecting a performance indicator of the application based on a first performance parameter;
identifying a set of errors from the plurality of errors using a causal machine learning (ML) model, wherein the set of errors are identified to test if the set of errors cause a fluctuation in the performance indicator;
determining performance data of the application in association with the set of errors based on the errors logs;
analyzing the set of errors based on an anomaly detection operation and the performance data;
determining that the set of errors cause the fluctuation in the performance indicator to meet or exceed a threshold change; and
directing an error resolution process to one or more causes associated with the set of errors, wherein the directing includes providing, in the error resolution process, a causal statement of the one or more errors and a confidence value that the set of errors cause the fluctuation.

18. The non-transitory machine-readable medium of claim 17, wherein the performance indicator comprises a percentage of application availability that is reduced when each of the plurality of errors occurs.

19. The non-transitory machine-readable medium of claim 17, wherein the determining the performance data comprises transforming the performance data to identify one or more fluctuations in the performance indicator caused by each error in the set of errors using a computation associated with a service level agreement (SLO) threshold or a business rule threshold.

20. The non-transitory machine-readable medium of claim 17, wherein the operations further comprise:
generating, prior to the detecting, the causal statement based on a hypothesis of the causal statement, wherein the hypothesis is associated with the set of errors and impacts of each error on other errors in the set of errors, and wherein the hypothesis is tested during the analyzing the set of errors.
